(19) United States
(12) Patent Application Publication
(10) Pub. No.: US 2026/0018895 A1
(43) Pub. Date: Jan. 15, 2026

(54) A MULTISTAGE ENERGY CONVERSION SYSTEM

(71) Applicant: Stephen PHILLIPS, Sydney (AU)

(72) Inventor: Stephen PHILLIPS, Sydney (AU)

(21) Appl. No.: 18/992,049

(22) PCT Filed: Jul. 20, 2023
(86) PCT No.: PCT/AU2023/050665

§ 371 Date: Jan. 7, 2025

(30) Foreign Application Priority Data
Jul. 21, 2022 (AU) 2022902037

(51) Int. Cl. H02J 3/32; H02J 7/02; H02J 7/34; H02M 7/797

(52) U.S. Cl. CPC H02J 3/32; H02J 7/02; H02J 7/34; H02M 7/797; H02J 2207/20; H02J 2300/24

(57) ABSTRACT

A power conversion system comprises a DC element, a source inverter interfacing an AC source and the DC element, a load inverter interfacing a load on the DC element and a controller. Voltage of an output of the load inverter is controlled by a controller to reduce power consumption according to a variable charge state of the DC element.

### FIELD OF THE INVENTION

This invention relates generally to electrical energy converters. More particularly, this invention relates a power conversion system which can be applied in the fast growing market for solar photovoltaic systems with energy storage that are typically interconnected to and rely on an external large AC grid network.

### BACKGROUND OF THE INVENTION

Interconnection of AC power electronic converters to the grid involves the synchronization of voltage, phase and frequency. However, voltage stability and harmonic content of most global grids have become less stable over time, thereby imposing fluctuations onto the consumer loads.

For example, the Australian National Grid often delivers excess voltage amplitudes during the daytime, wherein a 240 VAC node may measure anywhere from 240 to 255 Volts during the course of a day.

Excess voltage results in higher than necessary meter readings given average power is directly proportional to supply voltage and this excess voltage is lost in deleterious heat within appliances and provides no benefit to the consumer.

### SUMMARY OF THE DISCLOSURE

An AC electric circuit element dissipates or produces power (P) according to P=I·V where I is the current in the element and V is the voltage across the circuit. The instantaneous power p(t)=i(t)·v(t) is time dependent. For a resistive circuit, i(t) and v(t) are in phase and have the same sign, + or − at any instant.

Many loads are mostly resistive in nature. However, some loads have capacitive or inductive components as reactances wherein the relative signs of i(t) and v(t) vary over a cycle due to phase differences. The vector summation of these components is the load circuit impedance Zc.

Consequently, p(t) is positive at some times and negative at others, indicating the impedances also deliver or absorb power at different instances.

The instantaneous power p(t) can also be considered over one power line cycle, i.e. the time average of the instantaneous power, Pave=1/T·∫p(t)·dt where T=2. TT/w is the period of oscillation.

The average power drawn by the load impedance can be shown to be Pave=½·Is·Vs·cos φ0 where cos φ is the power factor. The power factor essentially quantifies losses, the effective power delivered in the circuit, being less than a theoretical maximum, due to components Is and Vs being out of phase.

It follows that the power demand on the source can be interpreted as follows, Pave=½··Is·Vs·cos =Vs2·Rc/Zc where Zc is proportional to the sum of the circuit Rc and the reactance, commonly inductive in nature, XI is expressed in the units of ohms.

However, the inductive reactance, XI, the magnitude of which contributes to the losses, is determined by XI=2·π·f·L where f is the system frequency and L is the component inductance in the units of Henries.

Therefore, from the circuit analysis it is seen that Pave can be reduced by reducing the impedance, with the careful optimization of the voltage and the system frequency.

As such, there is provided herein a multi stage, back-to-back power conversion system wherein Pave can be reduced by reducing the impedance by optimised control of the voltage and the frequency thereof according to DC element charge level control inputs.

The present system comprises two independently controller DC-AC inverters, each preferably having ultrahigh efficiency of >99%.

These inverters comprise a source converter for an AC source (typically the grid) and a load inverter for a load, typically comprising one or more consumer appliances.

Each inverter is operably coupled to a DC element holding a specific charge, often a suitable capacitor but which may also take the form of an electrochemical battery.

The source inverter, operative between the DC element and the AC source has an output Vs which may be controlled by a bi-directional T Neutral point clamped (TNPC) multi level converter where grid power can be imported to or exported from the DC element.

Whereas a standard TNPC typically uses three half bridge power stages to achieve three levels, the present system may employ ultra-high frequency interlaced pulse width modulation into two H Bridge power stages to achieve a five-level control.

The load inverter interfaces the DC element and the load and is a unidirectional converter having an output which delivers power from the DC element to the consumer load.

The present system further comprises a controller which independently controls the voltage and frequency of the inverters according to the charge of the DC element.

For example, the controller is configured to set the voltage and/or frequency of the output of the load inverter according to measured voltage and frequency of the AC source when the charge is high.

Further, the controller is configured to reduce at least one of the voltage and frequency of the output of the load inverter when the charge is deemed low.

The control algorithm for the parallel operation of the inverters may take the form of an artificial neural network having a number of input layer feeding two output layers whereby maximum weighting of the inputs is the DC element charge. Other inputs may include be the solar power, the ambient temperature, the time of day and the like.

The grid interfacing source inverter may effectively buffer the power stage where excess solar energy might be exported to the grid. Any local energy shortfall from the solar shortfall can be imported from the grid optimally into the DC element with a ramp rate current control link embedded in a proportional integrated differential loop (PID).

The local inverter interfaces the consumer load where the crucial energy optimization by the controller occurs. Control of the load inverter may be based on linear and nonlinear, modified hyperbolic control.

Back-to-back control of the inverters is based on the continuous calculations by the controller (such as using the neural network) and may be on a power line cycle by cycle basis whereas the charge of the DC element will consistently fluctuate due the variable prevailing circuit conditions.

A typically Australian residential house draws 20 kWh of electricity per day (7.3 MWh per year) causing fossils fuels emissions of about 7 tonnes of CO₂ per year.

Our data estimates that a typical implementation of the present converter proposed system would save about 20% of the energy and reduce CO₂ by over 1.4 tonne per year per house, representing 14 tonnes over ten years or 14 million tonnes if used on 1 million houses.

This reduction in energy consumption, assuming 27.5 cents/kWh, could save $305 per year for the example house. Over 10 years the NPV of these direct cashflow savings would be $2,355 in 2021 dollars. If the present system product were installed on 1 million houses in Australia, it is estimated that NPV savings would be $2,355 billion over 10 years.

Furthermore, consumers could expect increased appliance lifetimes, estimated at 25% increase by reducing thermal dissipation in the connected home appliances.

Australia has 10 million houses and over 3 million have rooftop solar, all being potential candidates to be retrofitted with solar PV and energy storage. The present conversion system may enable the new reduced load will require a lesser amount of solar PV and storage.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows a logical schematic of a power conversion system;

FIGS. 2 and 3 show simplified circuit schematics of the power conversion system; and

FIG. 4 shows an exemplary circuit of the power conversion system.

### DESCRIPTION OF EMBODIMENTS

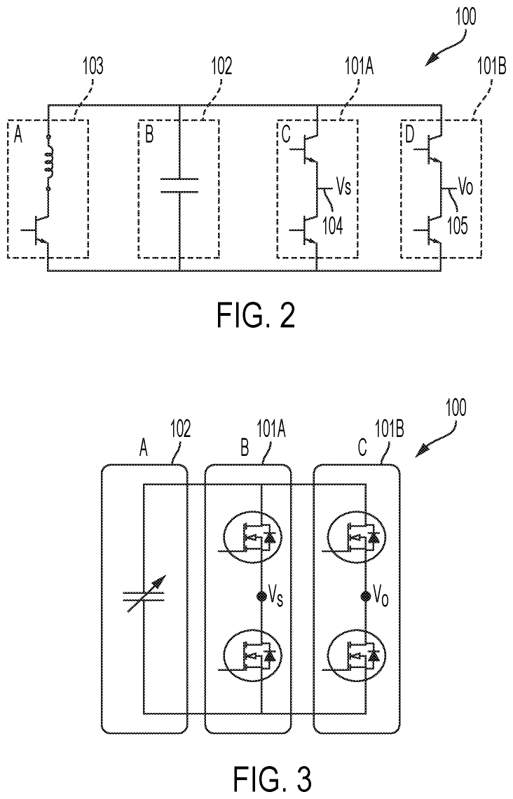

FIG. 2 shows a simplified schematic of a power conversion system 100 involving back-to-back inverters 101 which interface a DC element 102 controlled by controller.

The controller may comprise a processor for processing digital data and computer program code instructions. The controller may be in operable communication with a memory device via a system bus. The memory device may be configured for storing digital data and computer program code instructions. In use, the processor fetches these computer program code instructions and associated data for implementing the control functionality described herein.

The computer program code instructions may be logically divided into a plurality of computer program code instruction controllers for various purposes. In embodiments, the controller may take the form of an on-premises microprocessor based controller.

Box A represents an intermittent DC source 103, typically a solar photovoltaic array or equivalent, such as a solar PV booster-buck converter.

Box B represents the DC element 102 which may take the form of a capacitor, battery storage or the like.

Box C represents a bidirectional source AC/DC inverter 101A interfacing the DC element 102 and an AC source, typically the grid. The source inverter 101A has an output 104 (shown as Vs) wherein the voltage and/or frequency (preferably both) thereof is controllable by the controller. The source inverter 101A is bidirectional in that when the charge state of the DC element 102 is high, the source inverter 101A can export power to the grid whereas, when the charge state of the DC element 102 is low, the source inverter 101A can import power from the grid.

Box D represents a unidirectional load AC/DC inverter 101B interfacing a load, typically one or more consumer appliances. The load inverter 101B has an output 105 (shown as Vo) wherein the voltage and/or frequency thereof is controlled by the controller to optimise power delivery to the load to reduce energy consumption.

Voltage and frequency outputs of the inverters 101 are independently controlled by a controller according to the charge state of the DC element 102.

The controller may implement triple stage control based on the charge of the DC element 102 and the power factor of the local consumer load.

The controller may reduce the voltage of the output 105 of the load inverter 101B based on the magnitude of the charge of the DC element 102. For example, the controller may reduce the voltage of the output 105 of the load inverter 101B to between 10 and 15% as compared to the voltage of the AC source.

In embodiments, the controller may be configured in modes of operation. These modes of operation may include an after-hours mode of operation wherein the controller may reduce voltage output of the output 105 of the load inverter 101B even further, by up to 25% as compared the AC source voltage to essentially keep appliances on standby after-hours.

A yet further mode of operation may include a mission-critical mode or blackout of operation when energy is scarce wherein the voltage of the output 105 of the load inverter 101B may be reduced even further to between 30-35% (i.e. approximately 180 V).

Furthermore, the controller may reduce the frequency of the output 105 of the load inverter 101B to reduce impedance and increase throughput efficiency.

Furthermore, the controller may control the voltage and frequency of the output 105 of the load inverter 101B nonlinearly according to the aggregate power factor as determined by a real time signature at the load impedance measured at the output 105 of the load inverter 101B.

This real time operational control may reduce energy consumption of the load by approximately 20% and provide other benefits, including appliance longevity.

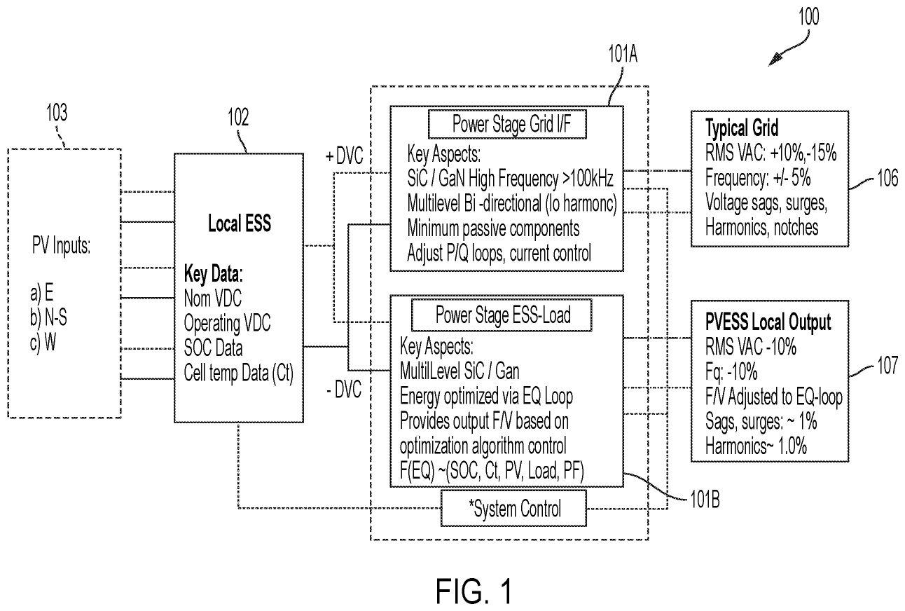

FIG. 1 shows a logical schematic of the present power conversion system 101 showing the source inverter 101A (shown as Grid I/F Power Stage) interfacing the AC source 106 (shown as Typical grid).

The schematic further shows the load inverter 101B (shown as ESS-Load Power Stage).

The schematic further shows the DC element 102 (shown as ESS).

The schematic further shows the optional variable DC supply 103, which may comprise a solar PV input.

As is shown, the AC source 106 may have RMS VAC varying from −15% to 10% from setpoint and frequency which may vary by up to 5% of setpoint. Furthermore, the AC source 106 may have brownouts, surges, harmonics notches and the like.

As alluded to above, the source inverter 101A is bidirectional so that power can be exported to the AC source 106 from the DC element 102 or imported from the AC source 106 to the DC element 102.

As also alluded to above, the load inverter 101B is unidirectional to provide power to the load 107 from the DC element. As is shown, the RMS VAC supplied to the load 107 may be reduced by 10% as shown in FIG. 1 but potentially further in scenarios as outlined above. Furthermore, the frequency supplied to the load 107 may be reduced by 10%.

The controller optimises the voltage and frequency of the output 105 of the load inverter 101B according to charge state of the DC element 102. As is also shown in FIG. 1, other inputs may be used by the controller which indicate the ability of the DC element 102 to deliver power. These inputs may include nominal VDC, operational VDC, state of charge, cellular temperature and/or the like.

FIG. 3 shows a yet further simplified schematic of the power conversion system 101 wherein stage A is the DC element 102, stage B is the source inverter 101A and stage C is the load inverter 101B.

The output voltage and frequency of stages B(Vs, fs) and C(Vo, fo) may be set, at the first order, by the coulombic charge (Aq) of the stage A DC element 102.

The output AC of the stage B may be a T type, quasi multilevel Bi directional structure with neutral point clamp control delivering (Vs, fs).

Coupled stage C is independently controlled by the controller to deliver optimised (Vo, fo) and may take the form of an H bridge.

At higher levels of DC element 102 charge the stage B(Vs, fs) may be set, at the second order, by synchronization to the external AC source.

At lower levels of DC element 102 charge the stage C(Vo, fo) may be reduced to lower the effective reactive power delivered to a local AC load.

Stages B and C may be implemented at 100 kHz control frequency with suitable power semiconductors.

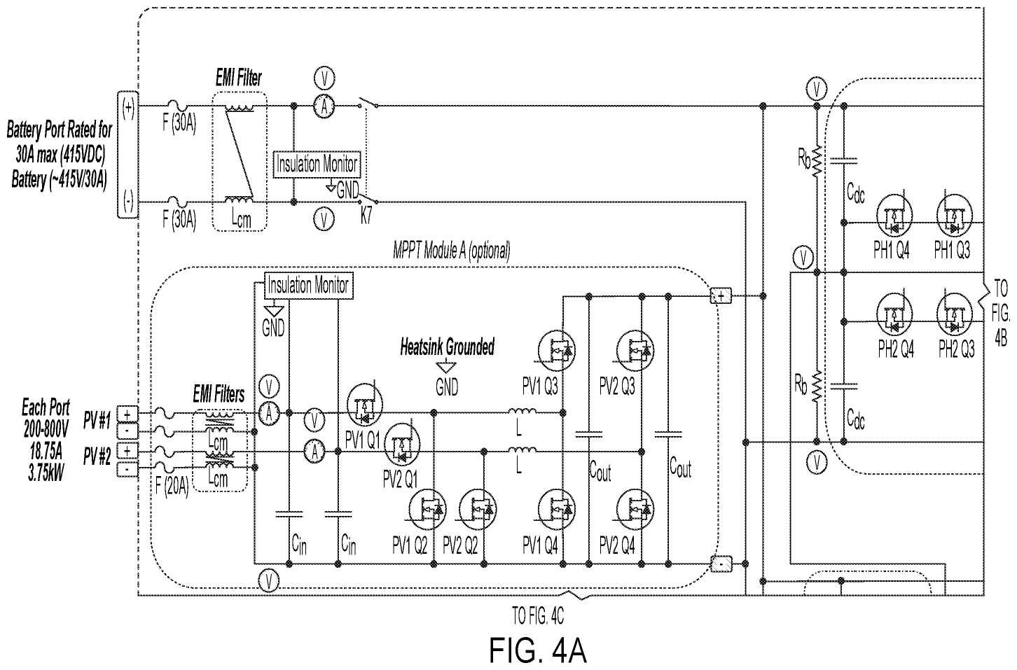

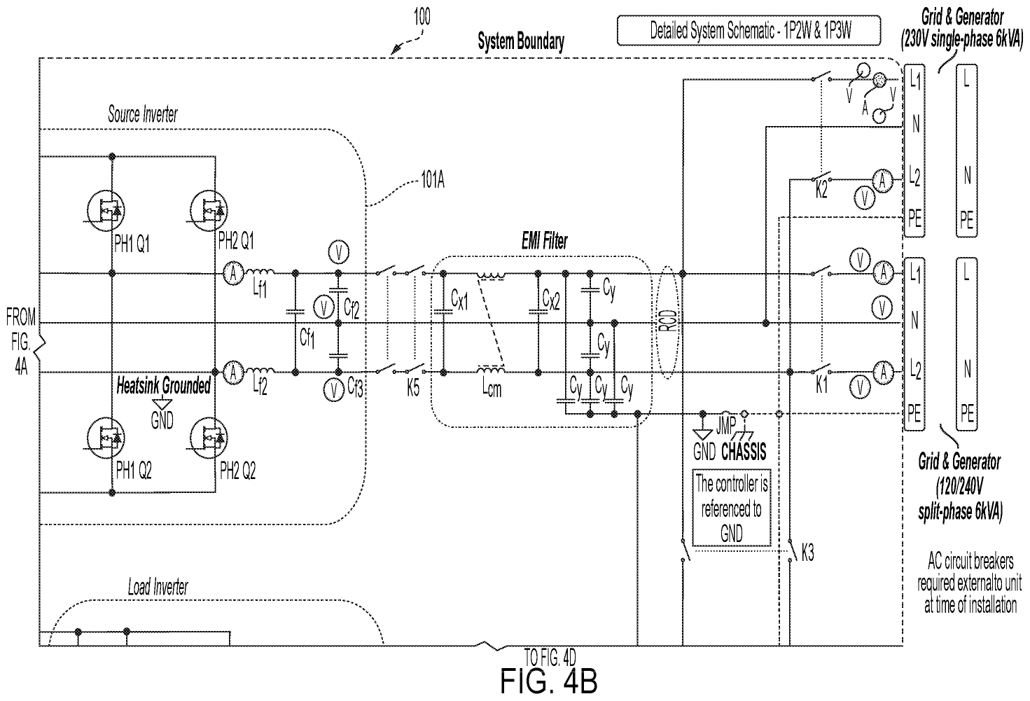

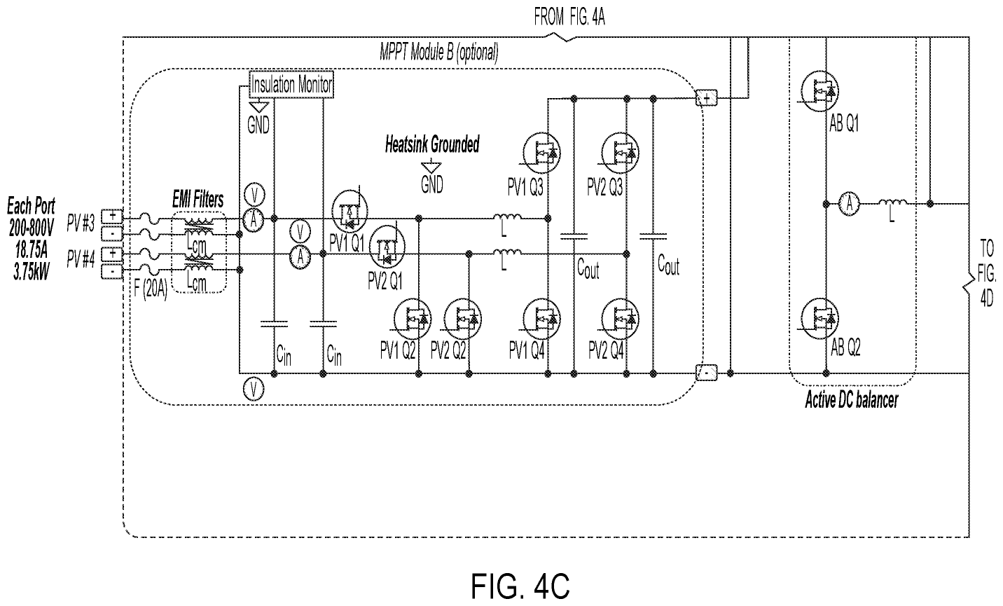

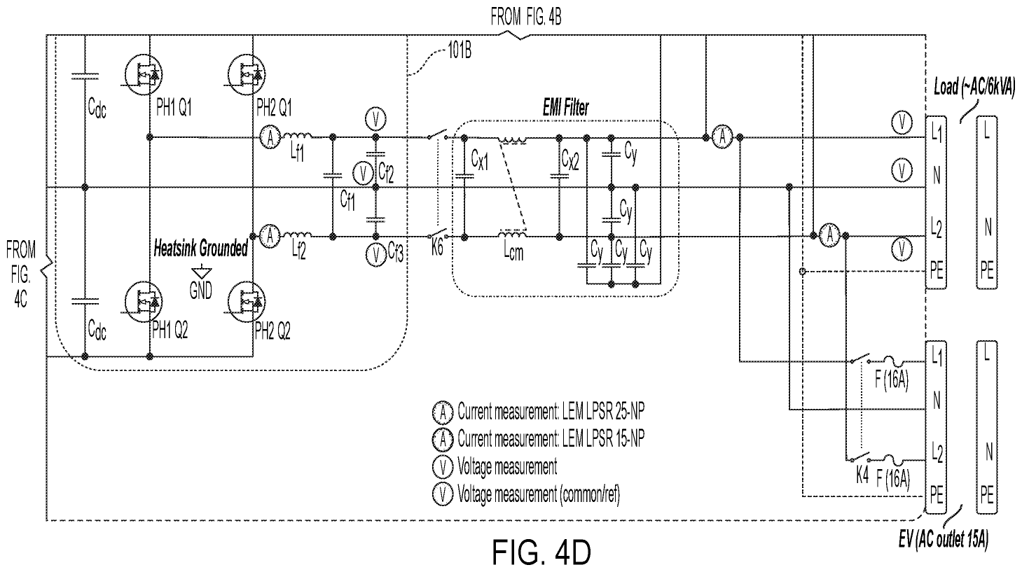

FIG. 4 shows an exemplary circuit diagram of the power conversion. As can be seen from the circuit, the load inverter is a T type, quasi multilevel Bi directional circuit with neutral point clamp control delivering (Vs, fs).

The coupled stage C is independently controlled by the controller to deliver (Vo, fo) and comprises an H bridge.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

1. A power conversion system comprising:
a DC element;
a source inverter interfacing an AC source and the DC element;
a load inverter interfacing a load and the DC element;
a controller, wherein:
voltage of an output of the load inverter is controlled by the controller to reduce power consumption of the load according to a variable charge state of the DC element.

2. The system as claimed in claim 1, wherein the controller reduces voltage of the output of the load inverter when the charge state is low.

3. The system as claimed in claim 1, wherein the controller reduces the voltage proportionate to magnitude of the charge of the DC element.

4. The system as claimed in claim 2, wherein the voltage is reduced by greater than 5% with respect to a voltage of the AC source.

5. The system as claimed in claim 2, wherein the voltage is reduced by greater than 10% with respect to a voltage of the AC source.

6. The system as claimed in claim 1, wherein frequency of the output of the load inverter is controlled by the controller to reduce power consumption according to the variable charge state of the DC element.

7. The system as claimed in claim 6, wherein the controller reduces the frequency of the output of the load inverter when the charge state is low.

8. The system as claimed in claim 7, wherein the controller reduces the frequency proportionate to magnitude of the charge of the DC element.

9. The system as claimed in claim 7, wherein the frequency is reduced by greater than 5% with respect to a frequency of the AC source.

10. The system as claimed in claim 7, wherein the frequency is reduced by greater than 10% with respect to a frequency of the AC source.

11. The system as claimed in claim 1, wherein the charge state is determined according to at least one of nominal VDC, operational VDC, state of charge and cell temperature data inputs of the DC element.

12. The system as claimed in claim 1, wherein the DC element is a capacitor.

13. The system as claimed in claim 1, wherein the DC element is a battery.

14. The system as claimed in claim 1, further comprising a variable DC source interfacing the DC element.

15. The system as claimed in claim 14, wherein the DC source is a solar PV DC source.

16. The system as claimed in claim 1, wherein the controller is configurable in modes of operation and wherein the controller is configured to control the voltage of the output of the load inverter according to the mode of operation.

17. The system as claimed in claim 16, wherein, in a mode of operation, the controller is configured to decrease the voltage by greater than 20%.

18. The system as claimed in claim 1, wherein the source inverter is bidirectional in that the source inverter is controllable by the controller to either:
export power to the grid from the DC element; or
import power from the grid to the DC element.

19. The system as claimed in claim 18, wherein the controller independently controls voltages of outputs of the load inverter and source inverter.

20. The system as claimed in claim 18, wherein the controller sets at least one of voltage and frequency of the output of the source inverter according to at least one measured voltage and frequency of the AC source when the charge state is high.

21. The system as claimed in claim 18, wherein the controller alters the phase of the voltage of the output of the source inverter depending on whether the charge state is high or low.

22. The system as claimed in claim 1, wherein the controller controls voltage and frequency of the output of the load inverter according to a load impedance power factor measured at the output of the load inverter.

23. The system as claimed in claim 1, wherein the load comprises at least one consumer appliance.

24. The system as claimed in claim 1, wherein the AC source is a utility grid.

25. The system as claimed in claim 1, wherein the source inverter comprises a neutral point clamp control circuit.

26. The system as claimed in claim 1, wherein the load inverter comprises an H bridge circuit.

27. The system as claimed in claim 1, wherein power semiconductors of the inverters are controlled at approximately 100 kHz control frequency.
